(19) United States
(12) Patent Application Publication
(10) Pub. No.: US 2007/0143408 A1
(43) Pub. Date: Jun. 21, 2007

(54) Enterprise to enterprise instant messaging

(76) Inventor: Brian Daigle, Marietta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/300,981

(22) Filed: Dec. 15, 2005

(51) Int. Cl. G06F 15/16

(52) U.S. Cl. 709/206

(57) ABSTRACT

Embodiments of the present disclosure provide methods and devices for communicating between private networks. In this regard, one embodiment of such a method, among others, can be broadly summarized by the following steps: receiving a request to initiate an active communication session between a first user of a local private network and a second user of a remote private network, wherein a secure link exists between a first messaging server of the local private network and a second messaging server of the remote private network; and forwarding the request to a client machine of the first user if the second user is authorized to communicate with the first user, as determined by policies of the first messaging server and policies of the second messaging server. Other methods and devices are also included.

### TECHNICAL FIELD

The present disclosure is generally related to electronic messaging and, more particularly, is related to electronic messaging over private networks.

### BACKGROUND

Instant messaging communications has become a popular way for people to communicate in their everyday lives. Businesses and other enterprises, however, are hesitant to fully employ instant messaging communications with other companies and vendors that they do business and otherwise interact with, because of the security risks that exist when communicating outside of a corporate or enterprise network that is under control of the business. Therefore, a corporation often employs an instant messaging server that is behind a corporate firewall so that only members of the business can communicate amongst each other using instant messaging. In this way, a business is limited by the fact that it is unable to utilize its enterprise instant messaging network to conduct business with another company, which may also be have its own enterprise instant messaging network.

Thus, a heretofore unaddressed need exists in the industry to address the aforementioned deficiencies and inadequacies.

### SUMMARY

Embodiments of the present disclosure provide methods and devices for communicating between private networks. In this regard, one embodiment of such a method, among others, can be broadly summarized by the following steps: receiving a request to initiate an active communication session between a first user of a local private network and a second user of a remote private network, wherein a secure link exists between a first messaging server of the local private network and a second messaging server of the remote private network; and forwarding the request to a client machine of the first user if the second user is authorized to communicate with the first user, as determined by policies of the first messaging server and policies of the second messaging server

Embodiments also include a computer readable medium having a computer program for performing the above steps. Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1-2 are block diagrams of embodiments of an enterprise to enterprise instant messaging system of the present disclosure.

FIG. 3 is flow diagram of an example communication session utilizing the enterprise to enterprise instant messaging network of FIG. 1.

FIG. 4 is a flow chart describing one embodiment of a method for communicating between two private networks utilizing the system of FIG. 1.

FIG. 5 is a flow chart describing one embodiment of a method for communicating between two private networks utilizing the system of FIG. 1.

FIG. 6 is a block diagram of a computer that can implement components of the system of FIG. 1.

### DETAILED DESCRIPTION

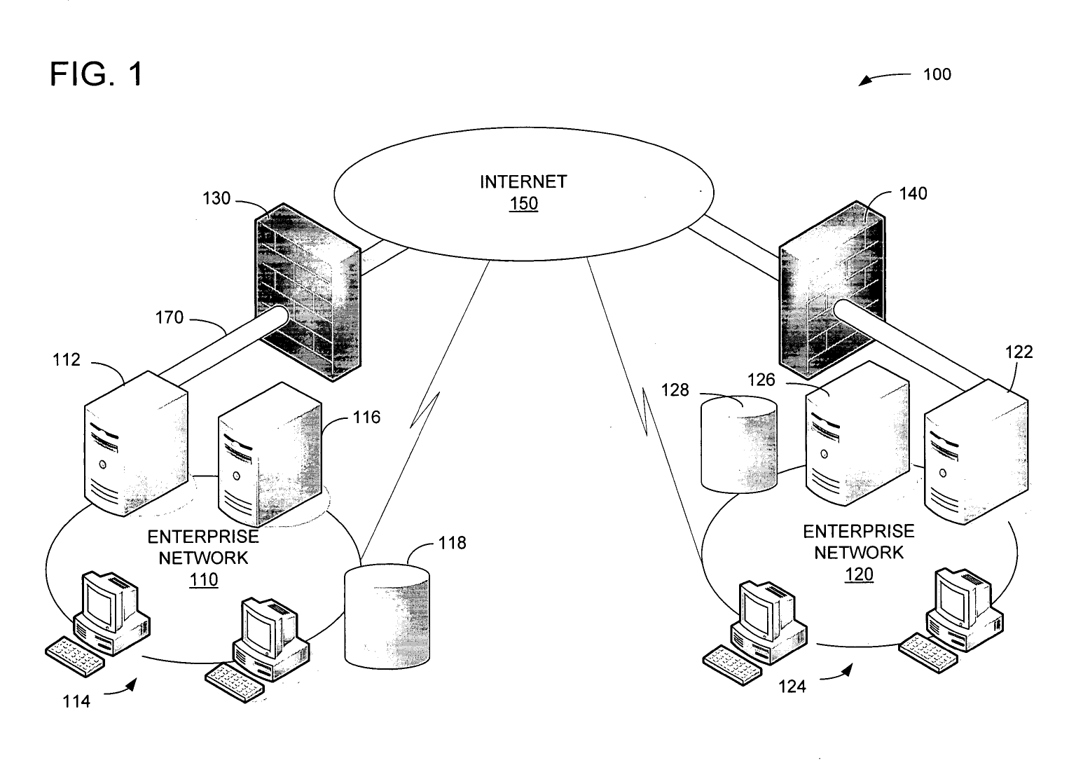

FIG. 1 is a block diagram of one embodiment of an enterprise to enterprise instant messaging system 100 featuring enterprise networks 110, 120. Within the enterprise network 110, 120, access to network resources are restricted and security precautions, such as encryption, are put in place to protect network components and data. For instance, each enterprise network may be behind a respective firewall 130, 140 that monitors and filters communications from an outside network, such as the Internet 150.

As an example, consider a business to business instant messaging system. In one context, a business or corporation “Business A” could utilize enterprise network 110 to provide computer network communications and services to its members (e.g., workers). As part of this enterprise network 110, an instant messaging server 112 may be provided to allow instant messaging communications between members of the business (via their client machines 114). Other network services may also be provided by other network servers 116 and databases 118. Business A may also have business relations with a company that is a vendor or business partner of Business A. This company may be referred as “Vendor B.”

Vendor B may utilize the enterprise network 120 of FIG. 1. As part of this enterprise network 120, an instant messaging server 122 may be provided to facilitate instant messaging communications between members of the company (via client machines 124). Vendor B's enterprise network 120 may also include other network servers 126, database 128, client devices 124 that are used in network communications and services.

Therefore, each enterprise network 110, 120 may include an enterprise instant messaging system, which is a complete instant messaging system that is hosted and run within a respective organization, such as Business A or Vendor B. Such systems allow extreme levels of control, management, and logging, which remove a large majority of the issues related to unmanaged public instant messaging systems.

As well as being able to centrally manage and control instant messaging use, enterprise instant messaging systems contain additional features useful to corporate applications such as centralized management, integration with directory services systems, and compatibility with third-party products such as virus protection software.

Additionally, client software provided with enterprise instant messaging systems may be more powerful than that available with public instant messaging systems. For example, some enterprise instant messaging clients can be implemented using a policy-based system allowing features to be enabled or disabled depending on the person logging on the system. While one user may have all features available to them, another might have certain restrictions, such as not being able to send files or add new users to the contact list. All of this functionality is controlled centrally, allowing changes to the enterprise instant messaging policy to be implemented quickly.

As previously mentioned, each of the enterprise networks 110, 120 may be protected by a firewall 130, 140 that protects the resources of the private network from users of other networks. The firewall 130, 140 may include or work with a proxy server that makes network requests on behalf of client computers 114, 124. A firewall 130, 140 is often installed in a specially designated computer separate from the rest of the network 110, 120 so that no incoming request directly interfaces with private network resources.

Therefore, the firewall 130 may allow members of Business A to access resources on the Internet 150 and control what outside resources the members have access to and further prevent users from the Internet 150 to access private data resources within the enterprise network. The same holds true for the enterprise network 120 of Vendor B with respect to firewall 140. Therefore, in many conventional systems, instant messaging communications between Business A and Vendor B would also be restricted since they are outside of each other's respective enterprise networks.

However, in accordance with an embodiment of the present disclosure, the enterprise networks are configured to allow a secure pipe or tunnel 170 to be provided between the instant messaging servers 112, 122 of the respective enterprise networks 110, 120.

According to an exemplary embodiment, the secure pipe is a logical configuration of a group of hardware components, such as firewalls 130, 140, that includes direct connection through the Internet 150. Data sent across the pipe or tunnel 170 is encrypted and secure. In this way, the enterprise networks of Business A and Vendor B are linked together in a secure manner via a virtual private network (VPN). This sort of arrangement allows certain users access to a fully operational instant messaging network expanding across Business A and Vendor B.

Note that special hardware configurations are not necessary for implementing the secure pipe 170 between enterprise networks 110, 120. For example, there are multiple ways to secure a link between two physical network locations. One way is to utilize IPsec (Internet Protocol Security) protocols between the two instant messaging servers 112, 122 so that the two servers can communicate with each other, while network rules and policies for the respective enterprise networks 120, 130 are maintained.

After a pipe 170 is secured in accordance with the present disclosure, an enterprise, such as a business, has a way to communicate with other enterprises, e.g., vendors and other businesses, (having enterprise networks) within a secure environment preferred by the enterprise and one that is not shared with outside parties. In accordance with one embodiment, access controls are still maintained by the instant messaging server 112, 122 of a respective network 110, 120 so that rules regarding to whom members can communicate are enforced.

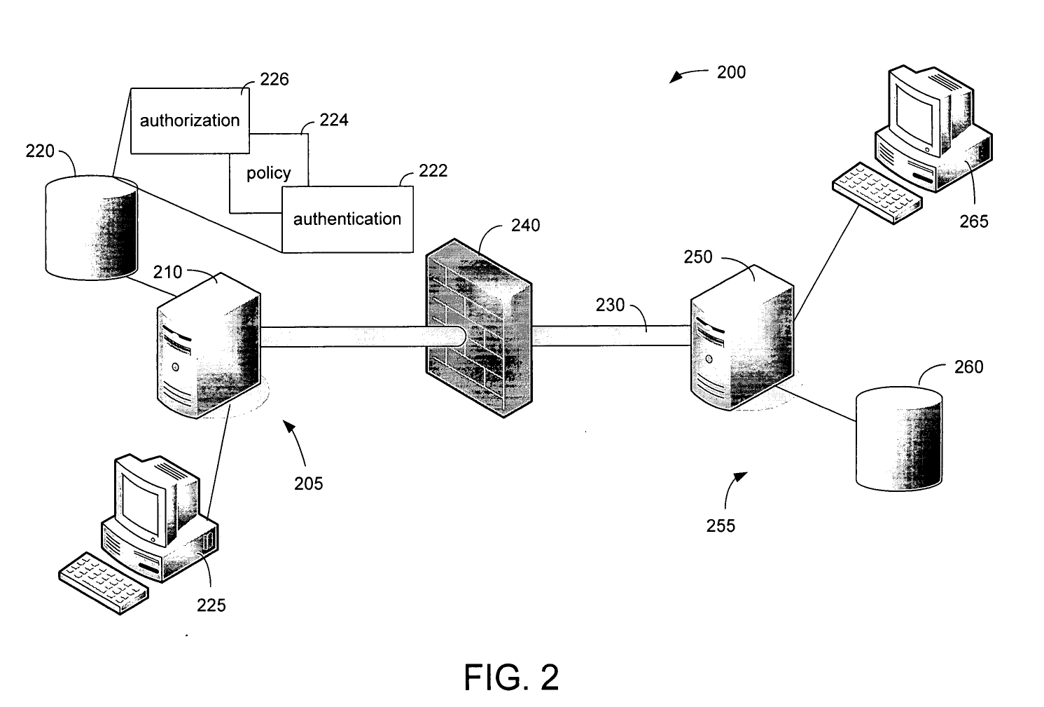

To further explain aspects of the present disclosure, attention is directed towards FIG. 2. In this figure, a representation of the enterprise to enterprise instant messaging system 200 is shown. Please note that some of the components of FIG. 1 are not shown in this figure but maybe still included in the system as a whole.

In FIG. 2, an instant messaging server 210, a database 220, and a computer client 225 of an enterprise network 205 are shown, and the enterprise network 205 is linked via a secure pipe 230 to an enterprise network 255 that also features an instant messaging server 250, database 260, and computer client 265. The respective networks 205, 255 are separated by one or more firewall(s) 240 that may be included at either enterprise network or both. Database 220 and database 260 may store and maintain information used by the instant messaging servers including authentication settings 222, security and policy settings 224, and authorization settings 226, etc. For one embodiment, enterprise instant messaging communications are accomplished by launching an instant messaging client application that attempts to connect to an instant messaging server 210, 250 on its enterprise network 205, 255.

The instant messaging server 210, 250 verifies a username and password of a member of the enterprise network 205, 255 and logs the client machine of the member on the network. Once it's logged on, the client is sent the names of everyone on the member's contact list. The instant messaging server 210, 250 creates a temporary session file that contains the connection information and checks to see who on the contact list is also logged on the enterprise network of the member or affiliated enterprise networks (e.g., an enterprise network with which it has a secure pipe connection).

When the server 210, 250 finds contacts who are logged on, it sends a message back to the member's instant messaging client application with their connection information, such as presence information, and sends the member's connection information to the contacts. As soon as all the connection information has been sent and acknowledged, instant messaging communications can begin.

With instant messaging communications occurring between, for example, businesses, it is likely that the communications may contain information that is confidential. For this reason, security measures are implemented to ensure protection of sensitive material. In one embodiment, the secure pipe 230 may be facilitated by a digital certificate being sent from an instant messaging server 210 attempting to initiate an instant messaging session with the other instant messaging server 220. This digital certificate is issued by instant messaging server 210 from one enterprise network 205 to an instant messaging server 220 of another enterprise network 250 to establish its authenticity. The instant messaging server 220 uses the data in the certificate to encrypt communication sent back to the instant messaging server 210. In this way, other network devices between the two servers cannot read nor tamper with the communication. To decrypt communications, the instant messaging server 210 uses a private key corresponding to the digital certificate. For communications from instant messaging server 210 to instant messaging server 220, the instant messaging server 220 may issue a digital certificate to instant messaging server 210 so that the instant messaging server 210 may use it to encrypt communications to instant messaging server 220. Instant messaging server 220 then uses a private key corresponding to its digital certificate to decrypt the communications. In some embodiments, the instant messaging servers 210, 220 may agree on a singular encryption key to be used in communications, such that a singular decryption key is also known and used by the respective servers.

Further, in accordance with one embodiment of the instant messaging network 200, an authentication protocol is employed by the instant messaging servers 210, 220 to authenticate a person before the person is allowed access to other members or resources of the enterprise network via instant messaging communications. For example, a user may be required to provide a user name and password that are recognized by the instant messaging server 210, 220 of the enterprise network of which the user is a member.

For example, if a user named “Bob” makes a request to an instant messaging server 210 to initiate an instant messaging session with another user “Todd,” the instant messaging server 210 attempts to authenticate that “Bob” is an authorized user of the instant messaging system. As such, the instant messaging server 210 accesses a user name and password provided by Bob for the instant messaging server 210 to determine if the user name and password combinations are valid. If the user name and password combination are valid, the instant messaging server 210 authenticates the user. If the user name and password combination are not valid, the instant messaging service 210 denies service until a valid combination is provided.

As an additional measure, an instant messaging server 210 may also need to determine whether a user requesting service is authorized to make the particular request or to access a particular resource. Therefore, in the previous example, the instant messaging server 210 may check whether Bob is authorized to communicate with Todd (or with the business in which Todd is a member, or with any group within that business).

For example, assuming that Todd is also a member of the same enterprise network 205 as Bob, rules may be established (and enforced by the instant messaging server 210) allowing Bob to only communicate with other users in his or her department (e.g., sales department), which may not include Todd. Therefore, Bob would not be authorized to start an instant messaging session with Todd.

If Todd is not a member of the same enterprise network 205 as Bob and is a member of another enterprise network 255 that is a part of the enterprise to enterprise instant messaging system 200 of the present disclosure, rules may exist that prohibit Bob from communicating with other users outside of his own enterprise network 205, such as Todd. However, the same rules may allow Bob's co-worker Roy to communicate with Todd.

Therefore, certain policies and rules may be set up in an instant messaging server 210, 250 of an enterprise network 205, 255 that allow or disallow access to and by members of the enterprise network 205, 255. These policies may be implemented at a granular level.

For example, policies may be implemented that allow certain users or group of an enterprise network to instant message with a particular group of another enterprise network. Thus, this allows two enterprises, e.g., two businesses, to allow communication between different organizations of the two businesses and set up the appropriate access rights between those people. Therefore, an instant messaging server 210, 250 maintains a record or data structure of associations and relationships between users and groups of users. Policies are enforced on each independent server with regard to their users.

It may be that policies are established to allow particular individual instant messaging servers to communicate with other particular instant messaging servers. In this case, a particular server domain from one enterprise network 205 may be mapped to a server domain of another enterprise network 255. Therefore, to provide instant messaging access to, for example, a new business or vendor, an instant messaging server domain of the new business/vendor may be added to a list of authorized instant messaging server domains that is recognized by an instant messaging server 210 and firewall components 240 of an enterprise network 205.

Referring back to the previous example of an instant messaging session attempting to be initiated by a user Bob with another user Todd, if Bob's instant messaging server 210 (i.e., the instant messaging server 210 employed by the enterprise network 205 utilized by Bob) authenticates and authorizes his request to communicate with the instant messaging server 250 of Todd, the request is sent from Bob's instant messaging server 210 to Todd's instant messaging server 250. When the instant messaging server 250 of the enterprise network 255 of which Todd is a member receives the message, it first attempts to authenticate Todd as a member of the instant messaging server 250, as generally discussed previously.

After authenticating Todd as a valid user, the instant messaging server 255 then checks whether Todd is authorized to receive communications from a user, such as Bob, whose client machine is from another enterprise network 205. Accordingly, there may be policies that are implemented by the instant messaging server 250 that specify whether Todd is allowed to receive communications from any outside sources, such as from the particular enterprise network 205 that Bob is a member, from a group of users that Bob is or is not a member, or from Bob specifically.

Therefore, the instant messaging server 250 utilized by Todd determines whether Bob is authorized to instant message Todd based upon the rules and policies in existence for the instant messaging server 250 of the enterprise network 255 of which Todd is associated.

Additionally, in some embodiments, an ability to use instant messaging contact lists across disparate and distinct enterprise networks exists so that a user at one enterprise network can have a user of another enterprise network on his or her contact list and monitor his or her network presence.

Generally, each user has his or her own contact list that is maintained on a client device or on the instant messaging server 210, 250. Via an instant messaging application, a user has the ability to add a user from a different instant messaging domain to his or her contact list. Since the instant messaging servers 210, 250 can communicate to each other over the enterprise to enterprise instant messaging network 200, a request to add another user to a contact list may be facilitated by the servers 210, 250 communicating the necessary information over the secure pipe 230.

For example, in the previous example, if Bob attempts to add Todd to his contact list, Bob's instant messaging server 210 may request that Todd's instant messaging server 250 authenticate Todd as valid user and vice versa. Upon receiving confirmation of the authentication of Todd, Bob's instant messaging server 210 may then check whether Bob is authorized to communicate with Todd. If so, Bob's instant messaging server 205 may add Todd to Bob's contact list.

In some embodiments, Bob's instant messaging server 210 may not add Todd to Bob's contact list unless Bob is also added to Todd's contact list. Therefore, Bob's instant messaging server 210 may make a request to Todd's instant messaging server 250 to add Bob to Todd's contact list. Accordingly, Todd's instant messaging server 250 may request Bob's instant messaging server 205 to authenticate Bob as a user and Todd's instant messaging server 250 may check whether Todd is authorized to communicate with Bob.

If all checks and measures are approved, then Bob is added to Todd's contact list and confirmation of such is sent to Bob's instant messaging server 205. To do so, each instant messaging server 210, 250 is equipped with logic for associating a contact list entry with an instant messaging server domain, so that an entry in a format not utilized by a local instant messaging server may be forwarded and routed to the instant messaging server that accepts that type of address format and is used by the user associated with the contact list entry. Further, in some embodiments, the instant messaging server may feature logic for translating or converting messaging formats of one remote instant messaging platform into a format used by a local instant messaging platform and vice versa.

Further, an instant messaging server 210, 250 of a user, such as Bob, having a contact list with another user, such as Todd, from another enterprise network 255 may request the local instant messaging server 250 of Todd to update his or her presence information so that the presence information for Todd is maintained current and may be monitored by Bob. When Todd's instant messaging server 250 detects a presence change with Todd, it sends a message back to Bob's instant messaging server 210 so that Bob's instant messaging server 250 may relay the information to Bob's instant messaging application.

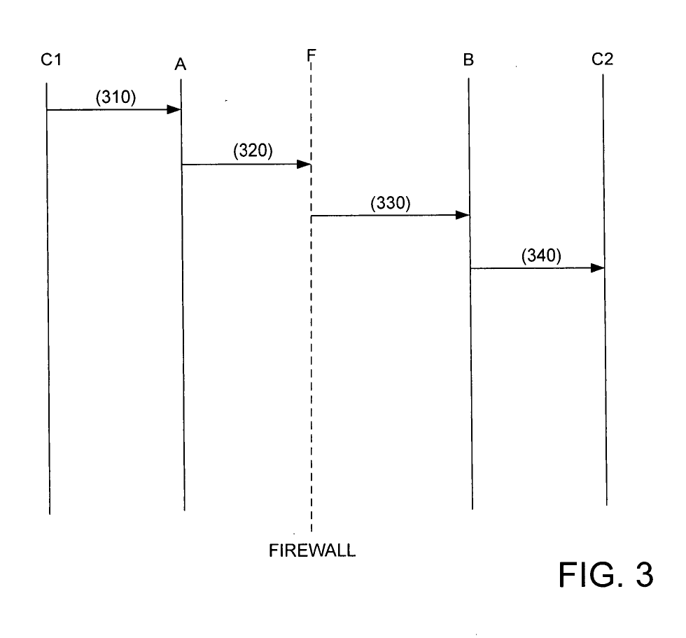

Next, FIG. 3 describes a flow diagram of an example communication session utilizing the enterprise to enterprise instant messaging network of FIG. 1. In FIG. 3, an instant messaging server of a first enterprise network is regarded as “A.” An instant messaging server of a second enterprise network is regarded as “B.” An instant messaging client of the first enterprise network is regarded as “C1.” An instant messaging client of the second enterprise network is regarded as “C2.” There is a one or more firewall devices F located between A and B and a secure pipe connection between A and B.

To start, C1 attempts to initiate a chat session with C2. The request (310) is transmitted from C1 to A. At this point, A may perform a check to determine whether C1 is authorized by the policy rules of the first enterprise network to communicate in the manner requested. Assuming that C1 is authorized, A forwards (320) the request to B where the firewall F is configured to allow the communication to pass (330) from outside the first enterprise network into the second enterprise network. B performs an operation to determine whether C1 is authorized to communicate with C2, based upon the policy rules of the second enterprise network. If C1 is authorized to communicate with C2, then the chat request is forwarded (340) to C2.

If C2 attempts to initiate a chat session with C1, a similar process occurs, where A may determine whether C2 is authorized to communicate with C1. It may be that A allows C2 and C1 to communicate but B does not, since each instant messaging server implements its own policies and rules.

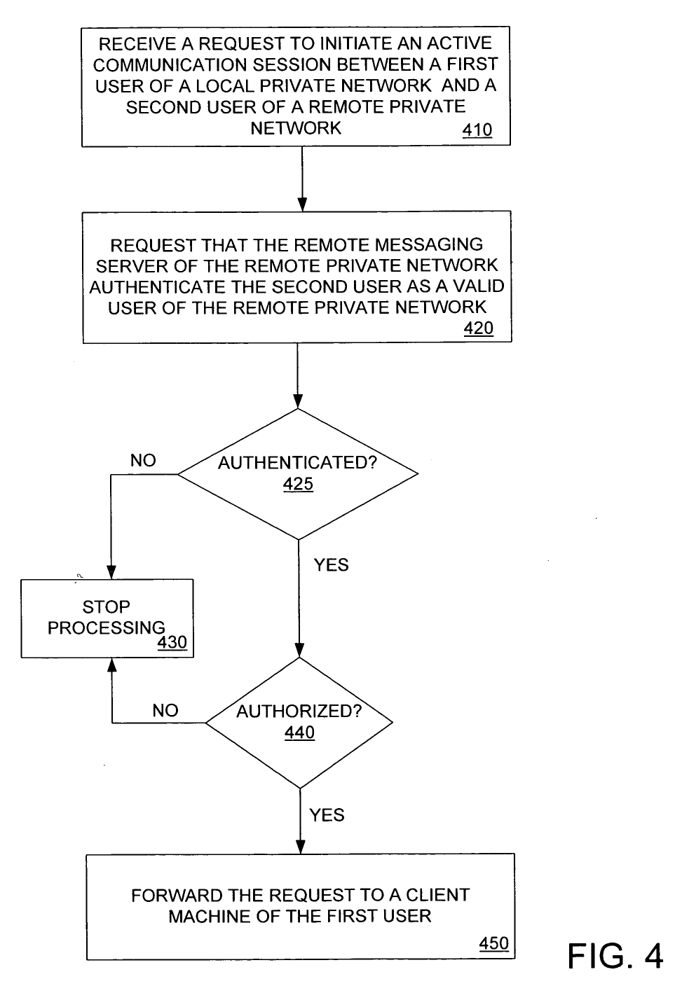

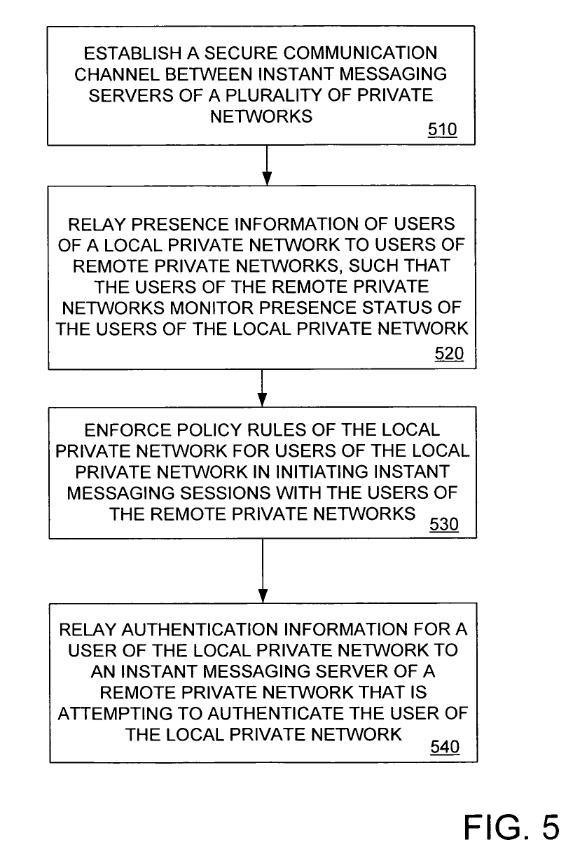

Referring now to FIG. 4, a flow chart describing one embodiment of a method for communicating between two private networks is shown. Beginning with block 410, a request is received, where the request is to initiate an active communication session between a first user of a local private network (e.g., an enterprise network) and a second user of a remote private network. A secure link or secure pipe exists between a first messaging server of the local private network and a second messaging server of the remote private network. Accordingly, the first messaging server requests (420) that the remote messaging server of the remote private network authenticates the second user as a valid user of the remote private network. If the second user is not authenticated (425-430), then the request is not processed any further by the first messaging server. If the second user is authenticated, the first messaging server may determine (440) whether the first user is authorized to communicate with second user in accordance with policy rules of the first private network. If the first user is authorized, then the request is forwarded (450) to a client machine of the first user in the case that the second user is authorized to communicate with the first user, as determined by the first messaging server. Otherwise, the request is not processed (430).

In the next flow chart, another embodiment of a method for communicating between private networks is illustrated. To begin with, a secure communication channel is established (510) between instant messaging servers of a plurality of private networks. Accordingly, presence information of users of a local private network is relayed (520) to users of remote private networks, such that the users of the remote private networks monitor presence status of the users of the local private network. This allows a user of the remote private network to be added to a contact list of the user of the local private network.

Further, policy rules of the local private network are enforced (530) for users of the local private network in initiating instant messaging sessions with the users of the remote private networks. Also, authentication information, which may not necessarily contain passwords or other credentials, for a user of the local private network is relayed (540) to an instant messaging server 210, 250 of a remote private network that is attempting to authenticate the user of the local private network.

Embodiments of the present disclosure allow self-contained and private networks to communicate with other private networks. Instead of adding an organization, such as a first business, to an internal network of a second business, the enterprise to enterprise instant messaging network of the present disclosure may be employed. While instant messaging communications has been discussed in relation to the prior examples, other modes of messaging may also be employed in similar manners, and the embodiments are not limited to an instant messaging environment.

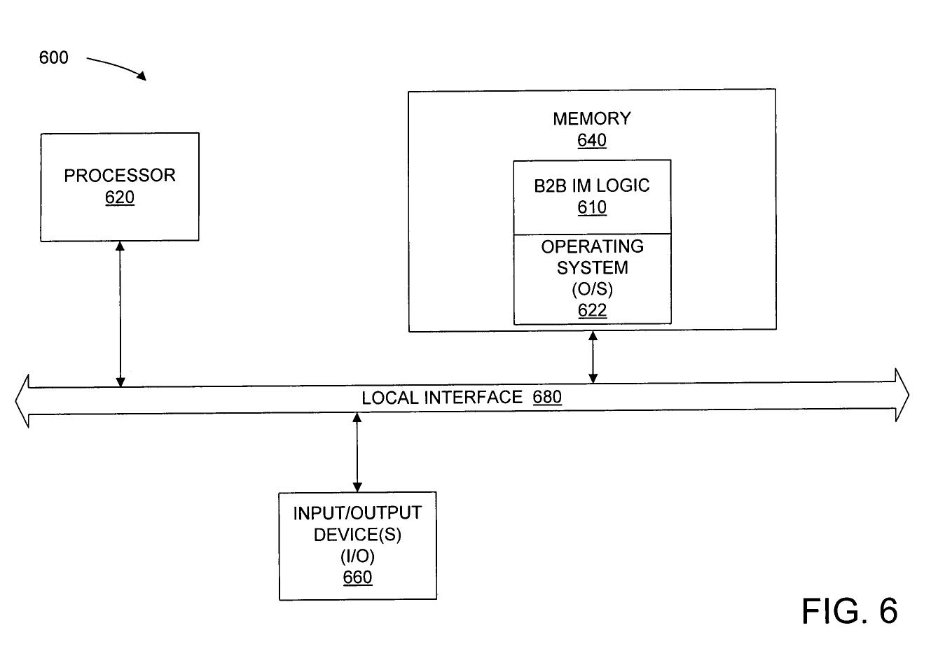

Embodiments of the present disclosure can be implemented in hardware, software, firmware, or a combination thereof. Logic components of the enterprise to enterprise instant messaging system may be implemented in software, as an executable program, and is executed by a server, special, or general purpose digital computer, workstation, minicomputer, or mainframe computer. An example of a computer that can implement logical components of the enterprise to enterprise instant messaging system 100 of the present disclosure is shown in FIG. 6. In FIG. 6, the enterprise to enterprise instant messaging logic is denoted by reference numeral 610.

Generally, in terms of hardware architecture, as shown in FIG. 6, the computer 600 includes a processor 620, memory 640, and one or more input and/or output (I/O) devices 660 (or peripherals) that are communicatively coupled via a local interface 680. The local interface 680 can be, for example but not limited to, one or more buses or other wired or wireless connections, as is known in the art. The, the local interface may include address, control, and/or data connections to enable appropriate communications among the aforementioned components.

The processor 620 is a hardware device for executing software, particularly that stored in memory 640. The memory 640 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 640 may incorporate electronic, magnetic, optical, and/or other types of storage media. Note that the memory 640 can have a distributed architecture, where various components are situated remote from one another, but can be accessed by the processor 620.

The software in memory 640 may include one or more separate programs, each of which comprises an ordered listing of executable instructions for implementing logical functions. In the example of FIG. 6, the software in the memory 640 includes business to business instant messaging logic (B2B IM Logic) in accordance with an exemplary embodiment and a suitable operating system (O/S) 622. The operating system 622 controls the execution of other computer programs and provides scheduling, input-output control, file and data management, memory management, and communication control and related services.

The I/O devices 660 may include input devices, for example but not limited to, a keyboard, mouse, scanner, microphone, etc. Furthermore, the I/O devices 660 may also include output devices, for example but not limited to, a printer, display, etc. Finally, the I/O devices 660 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

When components of the enterprise to enterprise instant messaging system 100 are implemented in software, the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method.

One or more components of the enterprise to enterprise instant messaging system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where one or more components of the enterprise to enterprise instant messaging system are implemented in hardware, the component(s) can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments are merely possible examples of implementations, merely set forth for a clear understanding of the principles of the disclosure. Many variations and modifications may be made to the above-described embodiment(s) without departing substantially from the spirit and principles of the present disclosure. All such modifications and variations are intended to be included herein within the scope of this disclosure.

Therefore, having thus described the invention, at least the following is claimed:

1. A method for communicating between private networks, comprising:
receiving a request to initiate an active communication session between a first user of a local private network and a second user of a remote private network, wherein a secure link exists between a first messaging server of the local private network and a second messaging server of the remote private network; and
forwarding the request to a client machine of the first user if the second user is authorized to communicate with the first user, as determined by policies of the first messaging server and policies of the second messaging server.

2. The method of claim 1, wherein the active communication session is an instant messaging session.

3. The method of claim 1, further comprising:
requesting that the remote messaging server of the remote private network authenticate the second user as a valid user of the remote private network.

4. The method of claim 1, further comprising:
checking policy rules of the first private network that include a rule expressing which users the first user is authorized to communicate.

5. The method of claim 1, further comprising:
checking policy rules of the second private network that include a rule expressing which users the second user is authorized to communicate.

6. The method of claim 1, further comprising:
relaying presence information from the second private network to the first private network, wherein a first user of the first private network is monitoring the presence of the second user of the second private network.

7. The method of claim 1, wherein the secure link is an encrypted communication channel between the first messaging server and the second messaging server being employed over a public network.

8. The method of claim 1, wherein the first private network is an enterprise network having a firewall for controlling access to outside network resources.

9. A computer readable medium having a computer program having instructions for communicating between private networks, the program for performing the steps of:
receiving a request to initiate an active communication session between a first user of a local private network and a second user of a remote private network, wherein a secure link exists between a first messaging server of the local private network and a second messaging server of the remote private network; and
forwarding the request to a client machine of the first user if the second user is authorized to communicate with the first user, as determined by policies of the first messaging server and policies of the second messaging server.

10. The computer readable medium method of claim 9, wherein the active communication session is an instant messaging session.

11. The computer readable medium of claim 9, the program further performing the step of:
requesting that the remote messaging server of the remote private network authenticate the second user as a valid user of the remote private network.

12. The computer readable medium of claim 9, wherein authorization is determined by checking policy rules of the first private network that include a rule expressing which users the first user is authorized to communicate.

13. The computer readable medium of claim 9, wherein authorization is determined by checking policy rules of the second private network that include a rule expressing which users the second user is authorized to communicate.

14. The computer readable medium of claim 9, further comprising:
relaying presence information from the second private network to the first private network, wherein a first user of the first private network is monitoring the presence of the second user of the second private network.

15. The computer readable medium of claim 9, wherein the secure link is an encrypted communication channel between the first messaging server and the second messaging server being employed over a public network.

16. The method of claim 1, wherein the first private network is an enterprise network having a firewall for controlling access to outside network resources.

17. A method for communicating between private networks, comprising:
establishing a secure communication channel between instant messaging servers of a plurality of private networks; and
relaying presence information of users of a local private network to users of remote private networks, wherein the users of the remote private networks are monitoring presence status of the users of the local private network.

18. The method of claim 17, further comprising:
enforcing policy rules of the local private network for users of the local private network in initiating instant messaging sessions with the users of the remote private networks.

19. The method of claim 17, further comprising:
relaying authentication information for a user of the local private network to an instant messaging server of a remote private network that is attempting to authenticate the user of the local private network.

20. The method of claim 17, further comprising: adding a user of the remote private network to a contact list of the user of the local private network.
